(19) United States
(12) Patent Application Publication
(10) Pub. No.: US 2011/0035210 A1
(43) Pub. Date: Feb. 10, 2011

(54) CONDITIONAL RANDOM FIELDS (CRF)-BASED RELATION EXTRACTION SYSTEM

(76) Inventors: Benjamin ROSENFELD, Holon (IL); Ronen FELDMAN, Petach Tikva (IL)

Correspondence Address: LADAS & PARRY LLP, 224 SOUTH MICHIGAN AVENUE, SUITE 1600, CHICAGO, IL, 60604, US

(21) Appl. No.: 12/852,678

(22) Filed: Aug. 9, 2010

Related U.S. Application Data
(60) Provisional application No. 61/273,961, filed on Aug. 10, 2009.

(51) Int. Cl. G06F 17/27

(52) U.S. Cl. 704/9

(57) ABSTRACT

A system for extracting information from text, the system including parsing functionality operative to parse a text using a grammar, the parsing functionality including named entity recognition functionality operative to recognize named entities and recognition probabilities associated therewith and relationship extraction functionality operative to utilize the named entities and the probabilities to determine relationships between the named entities, and storage functionality operative to store outputs of the parsing functionality in a database.

### REFERENCE TO RELATED APPLICATIONS

Reference is made to U.S. Provisional Patent Application Ser. No. 61/273,961, filed Aug. 10, 2009 and entitled “CONDITIONAL RANDOM FIELDS (CRF)-BASED RELATION EXTRACTION SYSTEM”, the disclosure of which is hereby incorporated by reference and priority of which is hereby claimed pursuant to 37 CFR 1.78(a) (4) and (5)(i).

### FIELD OF THE INVENTION

The present invention relates to automatic extraction of complex relations from free natural language text.

### BACKGROUND OF THE INVENTION

Trainable Machine Learning-based sequence classifiers are proficient at performing tasks such as part-of-speech (PoS) tagging (Avinesh, P. and Karthik, G. 2007. Part-Of-Speech Tagging and Chunking using Conditional Random Fields and Transformation Based Learning. Proceedings of SPSAL 2007), named entity recognition (NER) (McCallum, A. and Li, W. 2003. Early results for Named Entity Recognition with Conditional Random Fields, Feature Induction and Web-Enhanced Lexicons. Proceedings of CoNLL-2003, Edmonton, Canada: 188-191; Zhang, T. and Johnson, D. 2003. A Robust Risk Minimization based Named Entity Recognition System. Proceedings of CoNLL-2003, Edmonton, Canada: 204-207), and shallow parsing (Zhang, T., Damerau, F. et al. 2001. Text Chunking using Regularized Winnow. Meeting of the Association for Computational Linguistics: 539-546; Sha, F. and Pereira, F. 2003. Shallow Parsing With Conditional Random Fields. Technical Report CIS TR MS-CIS-02-35, University of Pennsylvania). However, they are less proficient at the task of relation extraction as shown by their relatively poor performance in Automatic Content Extraction (ACE) relation extraction shared tasks.

There are several reasons for the poor performance of Trainable Machine Learning-based sequence classifiers in relation extraction tasks.

Firstly, relation extraction is structurally more complex than PoS tagging, NER and shallow parsing. PoS tagging, NER, and, to a lesser extent, shallow parsing can be easily and precisely formulated in terms of sequential classification whereas relations, especially non-binary ones, often require multi-level structures, at least in the intermediate form during parsing.

Secondly, the volume of useful training data available for relation extraction in a corpus of a given size is significantly lower than that available for PoS tagging, NER and shallow parsing. In a reasonably-sized training corpus tens of thousands instances of each token class (e.g., “Noun” part-of-speech or “Person” entity) may be found but at best only several hundred instances of relations. Achieving a comparable level of accuracy for relation extraction as for entity extraction (95% F1-measure or higher) using the same algorithms requires a much larger training corpus.

Currently, the task of relation extraction is usually formulated as extraction of binary relations between entities, which entities are assumed to be known, for example by means of having been extracted by a separate NER component. Such formulation allows the task to be modeled as a classification-of-pairs-of-entities problem or as a sequence classification problem. However, this approach has limited applicability since it cannot easily be generalized to relations with multiple and variable number of slots. Furthermore, attempts to combine several different binary relations into a single n-ary relation fail because the interdependencies between the relations are missed. In addition, the sentence structure complexity is missed unless a full parsing of the sentences is first performed. However, full parsing is relatively inaccurate due to ambiguities that cannot be resolved without reference to semantic processing, which semantic processing is only performed following parsing and therefore cannot inform the parsing. Also, full parsing is costly and, since only a small number of sentences contain instances of the target relation, performing it on every sentence is wasteful.

Rule-based entity and relation extraction systems based on context-free grammars are long known (Feldman, R. 2002. Text Mining. Handbook of Data Mining and Knowledge Discovery, Kloesgen, W. and Zytkow, J. Cambridge, Mass., MIT Press). Such systems are notoriously difficult to build and maintain due to a large number of rules and exceptions and the necessity of resolving every ambiguity by using rule ordering or complex constraints.

Systems that learn rules automatically from training data have also been tried, but with limited success (Freitag, D. 1997. Using grammatical inference to improve precision in information extraction. ICML'97. Nashville, Tenn.; Soderland, S. 1999. Learning Information Extraction Rules for Semi-Structured and Free Text. Machine Learning 34(1-3): 233-272; Aitken, J. S. 2002. Learning Information Extraction Rules: An Inductive Logic Programming approach. 15th European Conference on Artificial Intelligence. Amsterdam; Kushmerick, N. 2002. Finite-state approaches to Web information extraction. 3rd Summer Convention on Information Extraction. Rome). Learning complex structures is very difficult for such systems and so the rules usually have a relatively simple “flat” form. Although the accuracy of automatic rules is relatively low for classic information extraction tasks involving finding and labeling all mentions of entities and relations in a given text, automatic rules may be successfully applied in redundancy-based settings, such as extracting many instances of a given relation from the Internet (Cafarella, M. J., Downey, D. et al. 2005. KnowItNow: Fast, Scalable Information Extraction from the Web. EMNLP 2005; Rosenfeld, B. and Feldman, R. 2007. Using Corpus Statistics on Entities to Improve Semi-supervised Relation Extraction from the Web. ACL-2007).

More recently, research has focused on relation extraction systems based on classification methods using arbitrary context features rather than rules. Such systems are typically only capable of extracting binary relations. (Zelenko, D., Aone, C. et al. 2003. Kernel methods for relation extraction. The Journal of Machine Learning Research 3: 1083-1106; Chen, J., Ji, D. et al. 2005. Unsupervised Feature Selection for Relation Extraction IJCNLP-05, Jeju Island, Korea)

Relation extraction based on full parsing of sentences and subsequent analysis of the parse trees are still state-of-the-art for more complex relations (Miller, S., Crystal, M. et al. 1998. Description of the SIFT system as used for MUC-7. Proceedings of the Seventh Message Understanding Conference (MUC-7)).

Systems based on partial and relation-specific parsing of sentences are less well known. Trainable Extraction Grammar (TEG) (Feldman, R., Rosenfeld, B. et al. 2006. TEG—a hybrid approach to information extraction. Knowledge and Information Systems 9(1): 1-18) is one such system and is the direct predecessor of CARE, which can be seen as a discriminative version of a generative TEG.

### SUMMARY OF THE INVENTION

The present invention seeks to provide a system for extracting complex relations from free natural language text.

There is thus provided in accordance with a preferred embodiment of the present invention a system for extracting information from text, the system including parsing functionality operative to parse a text using a grammar, the parsing functionality including named entity recognition functionality operative to recognize named entities and recognition probabilities associated therewith and relationship extraction functionality operative to utilize the named entities and the probabilities to determine relationships between the named entities, and storage functionality operative to store outputs of the parsing functionality in a database.

There is also provided in accordance with another preferred embodiment of the present invention another system for extracting information from text, the system including parsing functionality operative to parse a text using a grammar, the grammar including a plurality of rules, at least some of the plurality of the rules having different weights assigned thereto, the parsing functionality employing the weights to select preferred results of the parsing, and storage functionality operative to store outputs of the parsing functionality in a database.

In accordance with a preferred embodiment of the present invention the parsing functionality includes named entity recognition functionality operative to recognize named entities and recognition probabilities associated therewith, and relationship extraction functionality operative to utilize the named entities and the probabilities to determine relationships between the named entities.

Preferably, both the weights and the probabilities are employed to select preferred results of the parsing. Additionally, the weights are trained using a labeled corpus. Alternatively, the weights are specified by a knowledge engineer. Preferably, the rules utilize results of sequence classifiers.

There is further provided in accordance with yet another preferred embodiment of the present invention a method for extracting information from text, the method including parsing a text using a grammar, the parsing including recognizing named entities and recognition probabilities associated therewith and utilizing the named entities and the probabilities to determine relationships between the named entities, and storing outputs of the parsing in a database.

There is yet further provided in accordance with still another preferred embodiment of the present invention a method for extracting information from text, the method including parsing a text using a grammar, the grammar including a plurality of rules, at least some of the plurality of the rules having different weights assigned thereto, the parsing employing the weights to select preferred results of the parsing, and storing outputs of the parsing in a database.

In accordance with a preferred embodiment of the present invention the parsing includes recognizing named entities and recognition probabilities associated therewith and utilizing the named entities and the probabilities to determine relationships between the named entities.

Preferably, both the weights and the probabilities are employed to select preferred results of the parsing. Additionally, the weights are trained using a labeled corpus. Alternatively, the weights are specified by a knowledge engineer. Preferably, the rules utilize results of sequence classifiers.

### BRIEF DESCRIPTION OF THE DRAWINGS

The present invention will be understood and appreciated more fully from the following detailed description, taken in conjunction with the drawings in which:

FIG. 1 shows an example of a sentence labeled by a relation extraction system constructed and operative in accordance with a preferred embodiment of the invention;

FIG. 2 shows an example of a CARE grammar which is used by the relation extraction system;

FIG. 3 shows an example of statistical results as calculated by the relation extraction system;

FIG. 4 shows another example of statistical results as calculated by the relation extraction system;

FIG. 5 shows yet another example of statistical results as calculated by the relation extraction system; and

FIG. 6 shows yet another example of statistical results as calculated by the relation extraction system.

### DETAILED DESCRIPTION OF PREFERRED EMBODIMENTS

The present invention relates to a hybrid Machine Learning/Knowledge Engineering-based system, referred to as CARE (CRF Assisted Relation Extraction), for extracting complex relations from free natural language text. CARE can be thought of as an engine or a core of a Natural Language Processing (NLP) system, which receives an input comprising a block or corpus of natural language text such as English, and returns an output comprising the block after being parsed and processed. The parsing and processing may include identifying simple categorical entities such as personal names or addresses, referred to as NER, as well as more complex tasks such as extracting relations between predefined entities, such as identifying a relation between a person, and the position of the person in a given company, also known as the PPC relation.

The present invention provides a system for extracting information from text including parsing functionality operative to parse a text using a grammar which includes named entity recognition functionality operative to recognize named entities and recognition probabilities associated therewith and relationship extraction functionality operative to utilize said named entities and said probabilities to determine relationships between said named entities, and storage functionality operative to store outputs of said parsing functionality in a database.

The system is based on weighted deterministic context free grammars, which work together with feature rich sequence classifiers. An extraction grammar of CARE is a set of manually written rules, which specify both the structure of sentences and the slot assignment rules in a simple unified syntax. The rules may include real-valued weights, which can either be trained using a labeled corpus or specified intuitively by a knowledge engineer, as will be shown hereinbelow. CRF is the mathematical structure underlying the algorithms used for stochastic parsing of the grammar.

The rules have access to the results of sequence classifiers such as an NER system or a PoS tagger. The interface between sequence classifiers and the grammar is a unique feature of the present invention. The interface is flexible in the sense that the grammar is able not only to access the classification results but also to modify the classification results according to the specific needs of the interface. The flexible interface is one of the key features of the present invention, as will be demonstrated in the experimental section hereinbelow.

The present invention is innovative in its use of a tree-based CRF for a “partial” focused parsing model and in its flexible interface between the parsing component and a lower-level sequence classification component.

In the following description, numerous specific details are set forth in order to provide a thorough understanding of the present invention. It will be apparent to one skilled in the art, however, that the present invention may be practiced without these specific details.

### Functionality and Architecture of CARE

Preferably, CARE is used as a parsing component of a fully automatic Web-to-DB relation extraction system. CARE parses short segments of input text, such as sentences or paragraphs, into entities, and labels the entities in a manner which enables a deterministic post-processor to produce a final set of relations after resolving co-references and combining knowledge extracted from different sentences of the same document.

The output of CARE is a labeled sentence or paragraph, wherein the entities, their types and which slots of which relations, if any, they occupy, are labeled. The labeling may be multi-level, whereby entities may comprise sub-entities having relations between themselves.

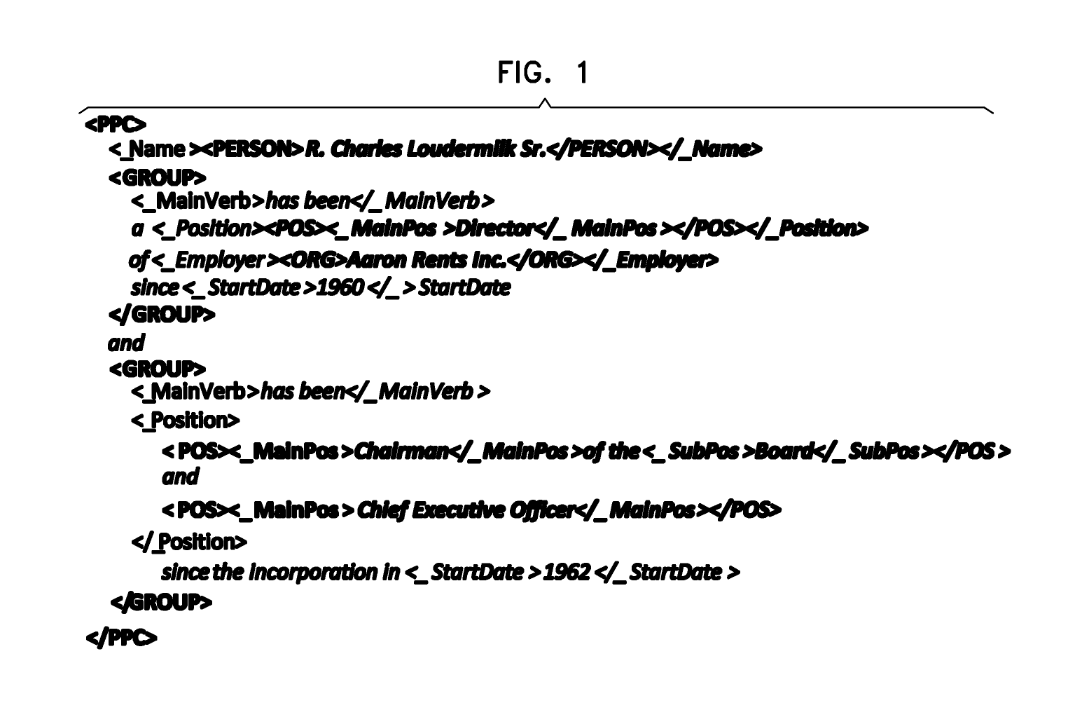

Reference is now made to FIG. 1, which shows an example of a sentence labeled by a relation extraction system constructed and operative in accordance with a preferred embodiment of the invention. The sentence shown in FIG. 1, with the exception of the final period, is a part of a Person-Position-Company (PPC) relation. The slots of the sentence are: Name, Employer, Position, StartDate, and MainVerb. The Name slot is occupied by an entity of the type PERSON, the Employer slot is occupied by an entity of the type ORG and the Position slots are occupied by entities of the type POS which are relations themselves, and may each comprise subslots MainPos and SubPos. Additionally, some of the entities of the PPC relation are grouped together under GROUP entities, and not have their own slots. The ownership of slots by relations is not apparent from the labeling of the entities, however it is implied by the definitions of the relations, as described hereinbelow.

Once the labeling of the entities is provided the final “flat” relation frames may be extracted. Three “flat” relation frames are shown in the example of FIG. 1:
PPC(Name=“R. Charles Loudermilk Sr.”,
   Position=“Director”,
   Employer=“Aaron Rents Inc.”,
   StartDate=“1960”),
PPC(Name=“R. Charles Loudermilk Sr.”,
   Position=“Chairman of the Board”,
   Employer=“Aaron Rents Inc.”,
   StartDate=“1962”),
PPC(Name=“R. Charles Loudermilk Sr.”,
   Position=“Chief Executive Officer”,
   Employer=“Aaron Rents Inc.”,
   StartDate=“1962”).

The role of a post-processor in producing such final relation frames is not described herein in detail.

The information that CARE uses to parse the input sentence and to produce the labeling as shown in FIG. 1 is obtained from two sources: a standalone token-level sequence classifier and a rulebook.

The standalone token-level sequence classifier receives a sequence of words or tokens as input, and labels each token with a tag from a small predefined set of tags. The most common sequence classifiers in NLP are NER systems, PoS taggers, and shallow parsers. State-of-the-art sequence classifiers are based on discriminative models such as CRF or Maximal Margin-based, which allow the use of arbitrary context features. These models use similar dynamical programming-based inference algorithms, differing only in the way the weights of various state transitions are calculated as functions of the context features. Because of the similarity between the models, CARE is able to function identically using any of the models.

The interface between CARE and the sequence classification is flexible, which, as mentioned above, is one of the most important aspects of the CARE architecture. Instead of running NER and/or PoS, and/or shallow parser systems separately and using their results as input, CARE receives as inputs the weights of state transitions and uses these weights as special context feature functions. This allows CARE to selectively modify a given trained model, adapting it in specific places and contexts but otherwise retaining unchanged scores. This results in significant flexibility as well as significantly improved accuracy as will be shown herein.

### Sequence Classifier Interface

The inference algorithm for a standalone sequence classification model comprises the following elements:
1. The Finite State Automaton (FSA) which includes a state for each possible token label and a transition between every pair of states.
2. The Transition Weights Function TF(Sequence, Position, Label, NextLabel)→R which, when provided with an input sequence and a position within the sequence, calculates the weights of the transitions from one state to any other state.
3. The Vitterbi Algorithm which calculates the sequence of states that maximizes the sum of the weights of all transitions for a given input sequence. This sequence of states is the classifier's output.

The Transition Weights Function is the most important and most complex element of those listed and is the only element that CARE uses. The transition weights function depends on the model type, on the set of context feature functions and on the training data that were used to train the model. Several possible model types, feature functions and datasets are described in (Rosenfeld, B., Fresko, M. et al. 2005. A Systematic Comparison of Feature-Rich Probabilistic Classifiers for NER Tasks. PKDD). In the experiments described herein a CRF model trained on a CoNLL-2003 dataset for the shared NER task was used (Tjong, E., Sang, K. et al. 2003. Introduction to the CoNLL-2003 Shared Task: Language-Independent Named Entity Recognition. Edmonton, Canada).

The method by which CARE uses the NER Transition Weights Function is now explained in more detail.

### Weighted Discriminative Context Free Grammar

The CARE parser is a weighted discriminative context-free grammar (WDCFG). A context-free grammar (CFG) is a precise description of a language defined by formation rules, in which every rule is of the form
V→w
   where V is a single non-terminal symbol, which is a symbolic placeholder, rather than an actual word in the language's lexicon, and w is a string of terminals which are words in the language's lexicon, and/or non-terminals. The term “context-free” expresses the fact that non-terminals can be rewritten regardless of the context in which they appear. A formal language is context-free if it is generated by a context-free grammar.

CFGs are used for analyzing the syntax of natural languages. The structure of CARE rulebooks, which will be described in detail hereinbelow, closely resembles the structure of a context free grammar, and the rules specified therein can be regarded as weighted context-free syntax generating rules. “Weighted” in this context means that each generating rule is assigned a weight, which is used by the CARE engine to find the highest-scoring parse and to determine which generating-rule should be applied.

The terminal symbols of the CARE grammar are token patterns. Such patterns may either match or not match a given token based on arbitrary properties of the token and its context, as well as on the classification of the token and the previous token according to the available sequence classification models.

The rules of the CARE grammar are conventional context-free production rules of the form
S→E₁E₂ . . . Eₖ
   where S is a nonterminal symbol and each E, is either a nonterminal or a token pattern. Every rule has a real-valued weight. One of the nonterminals is designated as a starting symbol.

During the inference process or parsing, the task of the system is to find a parse (a tree of expansions of rules, the leaves of which are terminals) which matches the input sequence of tokens and has a maximal total weight among all such parses. The total weight is a sum of the weights of all rules participating in the grammar, with the addition of the weights of all participating sequence classification transitions.

### Grammar as a CRF

A WDCFG can be interpreted as a CRF over the set of input sequences and their possible parses. In a preferred embodiment of the present invention, this interpretation is achieved by translating the grammar into a set of FSAs, in order to simplify the description of the algorithms. This may also be achieved by translating the grammar into an equivalent grammar of a Chomsky Normal Form, as in (Taskar, B., Klein, D., et al. 2004. Max-margin parsing. EMNLP ACL 2004).

In an FSA representation, each nonterminal symbol of the grammar gives rise to an FSA with one starting state and one finishing state and with weighted transitions labeled by terminal, nonterminal, or “empty” symbols. The FSA for a nonterminal is built in a manner wherein every path from the starting state to the ending state corresponds to a single rule of the nonterminal, and each such path contains exactly one transition with a weight equal to the weight of the rule. The weights of all other transitions are zero.

The CRF that corresponds to the grammar can be formally defined as follows: let X be the set of all possible input sequences and Y be the set of all pairs of the form (state, pos), where state is a state in one of the FSAs, and pos is a position within a sequence. In the graphical model of the CRF, the pairs are nodes and a pair (state₁, pos₁) is connected to (state₂, pos₂) if there is a transition from state₁ to state₂ and pos₁≦pos₂.

The CRF model defines a conditional probability

P(y|x)=Z(x)⁻¹Π_{c}(Σᵢfᵢ(x, c, y_{c}))

where c ranges over the 2-cliques of the graphical model, which are, basically, transitions with specified places. Only 2-cliques are used in order to keep the inference in the model tractable. For larger cliques, the values off are assumed to be zero.

There are K+L feature functions fᵢ, where K is the number of rules and L is the number of available sequence classification models. Given an input sentence x, the value of the i-th feature function for i≦K is:

fᵢ(x, i, t, from, to))=1, if t is the non-zero-weighted transition that corresponds to the i-th rule;

and otherwise:

fᵢ(x, i, t, from, to))=0.

For i>K:

fᵢ(x, i, t, from, to)=TF_{i-K}(x, from, t.Label_{i-K}, t.PrevLabel_{i-K}), if t is a terminal transition;

and otherwise

fᵢ(x, i, t, from, to)=0.

The t.Label and t.PrevLabel denote the classification labels allowed for the token by the transition's token pattern.

The interpretation of a WDCFG as a CRF allows a CRF training algorithm to be used, given a training corpus, to set the weights of rules automatically. Assuming there is a set of training sequences {x^{(k)}}, for which the correct parses {y^{(k)}} are known, the rule weights wᵢ can be set to maximize the (Gauss-penalized) log-likelihood:

L(w)=Σₖ log P_{w}(y^{(k)}|x^{(k)})−Σᵢσᵢ(wᵢ−αᵢ)²

where P_{w}(y|x) is the conditional probability of y given x, assigned by a CRF with the weight vector w. Usually, for i>K, αᵢ=1 and σᵢ=∞ are set. For i≦K, αᵢ=0 and σᵢ=1 are set.

In principle, this method allows optimal setting of the weights. However, a large volume of training data is required even for a moderately small number of rules. Fortunately, for rules written by humans, the weights have a simple meaning that can be easily grasped intuitively: the weight of a rule is the strength of a “force” that compels the parser to include the rule in the final parse if the rule matches. Provided that the orders of magnitude of the weights are correct, the precise values of the weights are insignificant. Thus, it is usually sufficient to use just six different weight values—“small”, “medium”, and “large” in magnitude, each of which may be positive or negative. These values can be specified manually in an intuitive manner, as will be shown in examples below.

### Rule Language of CARE

A grammar, its connection to the sequence classifiers and its output-producing directives are all defined within a rulebook, which is a text file written in a special-purpose formal language. A rulebook contains the following parts: declarations of the sequence classifier models, declarations of the target relations and a definition of the WDCFG.

### Entity Declarations

In a preferred embodiment of the present invention only one sequence classifier model, which is a CRF-based named entity recognition model trained on the CoNLL-2003 shared task data, is used. Thus, a sequence classifier declaration specifies the file containing the NER model and the set of NER labels that can be used as terminal symbols within the grammar specification. This set contains the labels PERSON, ORG, LOC and “None”, which includes everything else.

### Target Relation Declarations

Target relation declarations specify the names of the target relations and their slots. Relations without slots are target entities. It is important to note that the output entities of CARE can be and often are different from the entity labels defined by the NER model.

Below are examples of declarations, suitable for describing the relations and entities shown in FIG. 1:
relation PERSON;
relation ORG;
relation PPC(Name, Position,
   Employer, StartDate,
   EndDate, MainVerb);
relation GROUP;
relation POS(MainPos, SubPos);
These declarations correspond to the example labeled sentence shown in FIG. 1.

### WDCFG

The WDCFG syntax is similar to the syntax of regular production rules. The EBNF of the grammar syntax is:

```
Grammar = { NontermDecl | Rule }.
NontermDecl = “nonterm” [“start”]
          Nonterm [“->” Relation].
Rule = Nonterm “:-” RHS.
RHS = [ “<” Weight “>” ]
    { Element [“->” Slot] } [ “|” RHS ].
Element = Nonterm | TokenPattern |
      “(” RHS “)” | “[” RHS “]” |
      “{” RHS “}” | Element “+”.
```

Nonterm, Relation and Slot are identifiers. The syntactic elements |, ( . . . ), [ . . . ], { . . . } and + constitute “syntactic sugar” and not required in principle but help greatly in practice. The | (OR) is equivalent to several rules with the same nonterminal. The other elements are translated into calls of additional unnamed nonterminals.

It is not necessary to declare nonterminals, with the exception of the start nonterminal, the relation-producing nonterminals and nonterminals that are used in a rule before their first rule appears.

For all rules used in the preferred embodiments of the present invention, the following patterns are sufficient:
1. The direct tokens. Syntax: token. Matches the token, classified as None.
2. The entities. Syntax: Label. Matches a sequence of tokens, all classified as EntityLabel.
3. The lists. Syntax: ListName. Matches a sequence of tokens, all classified as None, that belong to a predefined list of sequences.

### Target Relations and Slots

As described hereinabove, the nonterminals can be declared to generate a target relation. When a relation-generating nonterminal appears in the final parse of a sentence, the fragment of text that matches the nonterminal will be marked by the tags <RelName> . . . </RelName>. However, the assignment of slots is specified by Elements which are the building blocks of the rules as specified in the EBNF. If an element with a slot assignment appears in the final parse of a sentence, the matching fragment of text will be marked by the tags <_SlotName> . . . </_SlotName>. Note that it is not necessary for slot assignments to appear within a rule for the relation-generating nonterminal. They may appear at any location within the parse tree, provided that the location is a descendant of such a nonterminal.

### Example Set of Rules

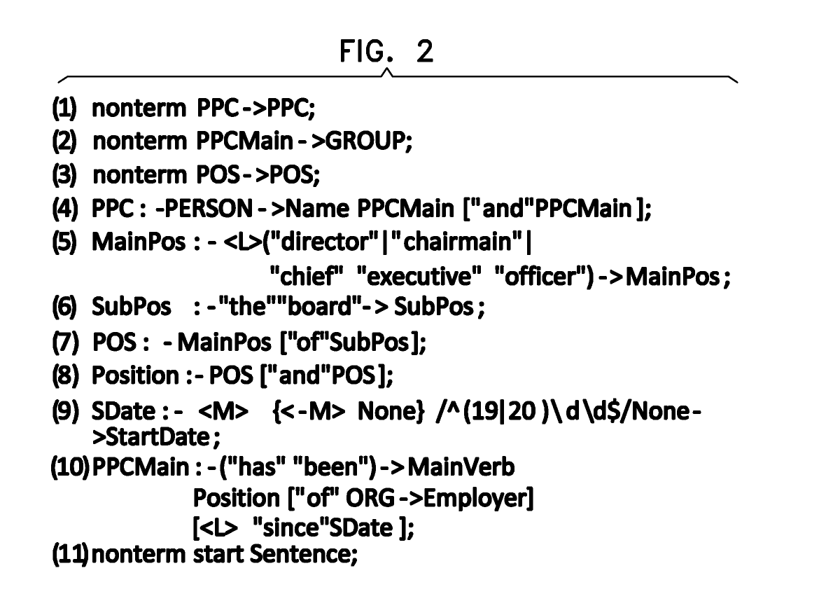

Reference is now made to FIG. 2, which shows an example of a CARE grammar which is used by the relation extraction system. A very simplified set of rules is shown for generating the labeled output shown in FIG. 1. This set of rules is used to demonstrate the essence of CARE rule writing, although obviously the actual rules employed are far more flexible than those shown in this example. The following points should be noted:
1. Only target relation nonterminals and the starting nonterminal need to be declared.
2. The rule weights are here defined using <L>, <M>, and <S> marks, which stand for Large, Medium, and Small magnitudes respectively. The weights may be negative. The letters L, M and S are actually macros, standing for 10, 1, and 0.1, respectively.
3. The MainPos weight is set to “large” (line 5), since the appearance of the specified words strongly forces the interpretation of them as positions. However, there is no such constraint in the SubPos rule (line 6).
4. The /̂(19|20)\d\d$/None token pattern (line 9) specifies a token that matches the “year” regexp and is classified as None by the NER model. Such a token suggests a date, where the suggestion is of a moderate strength. Arbitrary tokens can be skipped in the same rule by the {<−M> None} clause, but each token would add a medium negative weight to the total.

5. The starting nonterminal Sentence (line 12) is defined as an arbitrary sequence of defined entities, relations, and “None”-s. The <−S> weight ensures that, all else being equal, the longest entities and relations would be chosen since they would produce fewest invocations of this rule.

### Internal Representation, Algorithms and Optimizations

As described hereinabove, the internal representation of a CARE grammar is a set of FSAs, with transitions being labeled by terminals and nonterminals, weights and output actions.

The allowed feature functions are such that given a segment within a sentence and a nonterminal matching the segment, the weights of the nonterminal do not depend on the parse of the rest of the sentence. Conversely, the weights of the rest of the parse do not depend on the chosen path through the nonterminal's FSA. This allows dynamical programming to be used to solve training and inference problems of the corresponding CRF. In the case of inference, if a best (“heaviest”) path is found for a given nonterminal and a given fragment within a sentence, it can be stored and reused. Similarly, in the case of training, if the total weight mass is calculated for a nonterminal and for a fragment, it can be stored and reused. This is the basis of employed training and inference algorithms.

### Building of the FSA

In a first step, the “syntactic sugar” referred to above is converted to an internal “austere” representation:

```
  NT :- ... (...₁ |...₂ |...₃) .... ;
is converted to
  nonterm Temp;
  Temp :- ...₁;
  Temp :- ...₂;
  Temp :- ...₃;
  NT :- ... Temp ... ;
Similarly, { ... } is converted to
  Temp :- ... Temp;
  Temp :- ;
and [ ... ] is converted to
  Temp :- ... ;
  Temp :- ;
```

After this step, each rule can be represented by a WCFG sequence

S→E₁E₂ . . . Eₖ

where each Eᵢ is either a nonterminal or a terminal (token pattern, NER label, or wordclass). Each Eᵢ may also be marked with an output tag, if so indicated by the source rulebook.

In the next step, an FSA is built for every nonterminal. Each rule adds a path from the beginning node of the FSA of its head nonterminal to the ending node. Every Eᵢ becomes a transition, labeled with Eᵢ and with “output tag actions” where appropriate.

For example, following the three steps detailed above, a rule
PPC PERSON→Name
   PPCMain {“and” PPCMain};
      becomes two FSAs:

### FSA for PPC:

N₁ - - - T₁₂ - - - >N₂ - - - T₂₃ - - - >N₃ - - - T₃₄ - - - >N₄

### FSA for Temp:

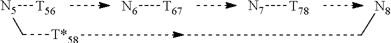

N₁ and N₄ are starting and ending nodes of the PPC's FSA and N₅ and N₈ are the starting and ending nodes of the Temp's nonterminal. Other nodes are internal. The transitions are:
T₁₂ is labeled with PERSON entity and with “NAME” output tag;
T₂₃ is labeled with PPCMain nonterminal;
T₃₄ is labeled with Temp nonterminal;
T₅₆ is labeled with “and”;
T₆₇ is labeled with PPCMain nonterminal;
T₇₈ is labeled with Temp nonterminal; and
T*₅₈ is an EMPTY transition (indicated by *).

In the next step, the set of FSAs is optimized, as described in the next section below.

Usually, parse-based CRFs are formulated in a manner which makes it possible for the feature function of a rule to depend on a caller. While a CRF with such dependency would still allow for a dynamical programming training and inference, its complexity would be significantly higher. Thus, such dependencies are preferably forbidden in preferred embodiments of the present invention. In the rare cases where such dependencies are necessary, they may be simulated by duplicating the corresponding FSAs.

### Optimizing the Set of FSAs.

The set of FSAs produced by the grammar according to the steps described hereinabove is highly suboptimal in that there are many unnecessary FSAs and extra transitions, leading to costs in terms of time and memory. The set of FSAs is optimized by applying the following four types of transformations:
1. Converting tail-recursive calls into transitions within FSAs.
2. “Inlining” an FSA inside calling FSAs. Inlining is only performed if it reduces the total complexity.
3. Removing unnecessary “empty” transitions.
4. Merging similar states and transitions.

The following are examples of the above optimizations:
1. The tail recursive transition T₇₈ from the Temp's FSA in the previous subsection is converted to an EMPTY transition T*₇₅ to N₅.
2. After this step is performed, there is only one transition T₃₄ in the entire set of FSAs that is labeled with Temp. Therefore, Temp's FSA can be inlined. This is done by removing T₃₄, and substituting two EMPTY transitions T*₃₅ and T*₈₄.
3. There is now a single FSA that appears as:

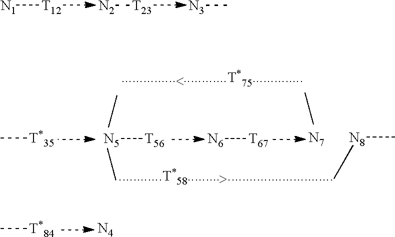

The four empty transitions are unnecessary and can be removed, by gluing together the nodes N₃, N₅, N₇, and N₈, which results in:

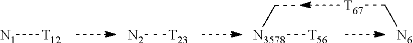

4. The states N₂ and N₆ are now outward-similar, since they each have matching outgoing transitions sets (i.e. their outgoing transitions are identically labeled and point to matching nodes, which are the same node in this case). This means they can be merged together, producing the final optimized FSA:

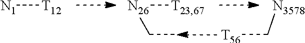

or, in a more visually appealing form:

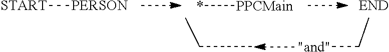

The limiting of a generic tree parse CRF and the optimization and programming steps described above improve the time and memory complexity by at least two orders of magnitude. This permits the use of far more complex grammars which are required in order to achieve the desired level of accuracy.

### Composing a Basic Rulebook

Detailed guidance for the composition of a basic rulebook is provided in this section. A rulebook can be written as a plain text file with an “*.rec” extension. Every rulebook begins with a preamble which includes several general definitions. In the preamble the NER model and general entities are defined, the basic sentence processing rules are specified and an optional set of macros and wordclasses are provided, as will now be described.

### Preamble

Formally, the only component required in a preamble is an NER declaration. However, it is a matter of convention and of good coding style to place the fundamental parsing rules, relation definitions, macros and wordclasses at the beginning of the rulebook for the purpose of order and clarity. This convention is adhered to in the composition of the CARE rulebook, and all general purpose macros and wordclasses are placed at the beginning of the rulebook. Note that once declared, specific or ad-hoc wordclasses and macros may be placed anywhere within the rulebook.

### NER and General Entity Declaration

Preferably, a rulebook begins with the following template lines:
NER BaseModelFileName @ (DefaultTokenFeature);
entity None=None<1;
   NER BaseModelFileName specifies the NER model to be used with the rulebook. As defined hereinabove, NER is an acronym for Named Entity Recognition which describes the function of the NER model. The NER model is the component that tells CARE how it is to identify several basic predefined entities. In a preferred embodiment of the present invention, a standard NER model known as NERCRF is used.

@DefaultTokenFeature is an instruction specifying the default token feature. A token feature is a property of tokens defined by regular expressions in the NER file. Formally it is a function which maps strings to strings. For example, a feature can be set to evaluate numeric characters, uppercase characters, or even whitespace characters. The default token feature used is ‘WordAll’ which takes the entire token and treats it as if it was in lowercase, regardless of its original case. Thus, provided that the default feature is not changed, CARE evaluates the text comprising the corpus as if it was entirely in lower case.

The above instruction follows the more general syntax:
entity NewNonTerminalSymbol=NERLabel<MaxLength;
   As such, the above instruction:
entity None=None<1
   creates a new CARE entity, a non-terminal symbol None, and assigns it the value None<1, which means any word not labeled by the NER model and comprising exactly 1 token. Note that the word None specifies something different on either side of the equality sign. Whereas the None on the right side is a standard NER label for any token that is not evaluated as matching a recognized named entity, the None on the left side is a non-terminal symbol or entity label declared within CARE. As a consequence of the definition above, any sequence of 1 to MaxLength tokens that is unrecognized by NER can be matched by the non-terminal symbol None. It is noted that any sequence of up to MaxLength may be matched by any corresponding nonterminal entity, the difference being the score NER assigns to each match.

### Sentence Processing Rules

Following the NER and general entity declaration, the sentence processing rules need to be specified:
concept start Sentence;
concept Phrase;
Sentence :- Phrase;
Phrase :- <−0.01, 0, 0> None Phrase;
Phrase :-;

‘concept’ is used to define a new non-terminal symbol ‘start’ which indicates that this is the initial symbol of the CFG and that all rules can be traced back to this symbol. In effect, the above predicate states:
“Define a new non-terminal symbol named Sentence, which will be the initial symbol of the CFG.”

It is noted that Sentence is only a name and may be replaced by any other identifier or case-sensitive sequence of alphanumeric characters and underscores which starts with a letter.

‘concept Phrase’ defines a new non-terminal symbol called Phrase, which will be used in the following rules.

‘Sentence :- Phrase;’ is the first rule of the CFG. It states the following:
“Allow replacement of the initial symbol Sentence with the non-terminal symbol Phrase.”

No weight is explicitly stated for this rule, in which case CARE assigns this rule a default weight of 0. This concept will be discussed in further detail herein.

‘Phrase :- <−0.01, 0, 0> None Phrase;’ is the second CFG rule. Whereas the first rule had no weight assigned to it, this second rule has three weight-related numbers assigned to it. The rule is a simple recursive directive stating:
“Allow Phrase to be prefixed by any unlabeled word (indicated by None).”

In effect, this rule, together with the next one, allows ‘Phrase’ to be comprised of any number of unlabeled tokens. The first number is called weight. Weight is the value that CARE will assign to every instance of this rule's application when calculating which parsing rule is most feasible. The higher the weight of the rule the more likely it is to be applied in generating an appropriate parsing. The very small negative weight in the above example (−0.01) is intended to discourage greediness, so that the rule is not applied repeatedly a large number of times. Note that the scale for the weight is relative to the weights assigned to the different rules and to the weights specified by the underlying NER model. A detailed explanation about weights and how to assign them will be provided hereinbelow.

The next two numbers are named prior weight and sigma, respectively. These values may be omitted, hence normal syntax usually includes only the first number which is used only for training, during which the weights of the rules are adjusted to optimize the accuracy of the extraction from the training data. This adjustment should not happen for entities defined by NER, such as None, since NER training will have already optimized these rules in the model, and they should therefore not be changed during the further relation-rule training. These values are rarely explicitly specified. The prior weight indicates the standard value of the weight and sigma specifies the prior strength. When the system trains, it will penalize the deviation of the weight from its standard value. By “penalize” it is meant that it will balance the magnitude of the difference between the weight and the prior weight against the fit of the model to the training data. The default prior weight is 0. The prior strength is a measure of how important the |prior -weight| deviation is versus the importance of the training fit. The default sigma is 1. Small values of sigma indicate a very strong prior weight, so that the trained weights will deviate very little from their prior weight value, and zero sigma means the weight will not be changed at all during training.

‘Phrase :- ;’ allows the empty word to be considered a phrase, thus guaranteeing a finite parse for recursive rules.

### Wordclasses, Relations and Macros

### Wordclasses

Wordclasses are explicitly defined sets of words or word-sequences used as lookup libraries as specified in the rules. The syntax for declaring a wordclass is as follows:
wordclass wcColors=black white yellow red blue purple pink (olive green) violet orange ;

Note that a sequence of words must be placed in parenthesis, e.g. (olive green) as shown above.

When the set is too large to be directly included in the rulebook, we can put it into a separate file and include it using an “%include” directive, as follows:
wordclass wcFirstName=% include(Wordclasses\wcColors.txt);

### Relations

Relations are the target labels which CARE uses to tag its output. In other words, relations are used strictly for output. In order to allow CARE to tag the corpus with a specific relation, one must tie the relation to a concept using the following syntax:
Concept→RELATION;

This will produce the respective XML tags
<RELATION> . . . </RELATION>
   whenever ‘Concept’ appears in the best parse for the sentence.

Each relation can have a number of slots or subfields, which are used as inner tags. A relation with no slots is simply an Entity, which is tagged as above using the corresponding concept. The tags corresponding to the slots of relations are slightly different, in that they are produced by rule elements, rather than by concepts. Also, the slots in the output are indicated by underscores appearing in their names as in:
<RELATION> . . . <_SLOT1> . . . </_SLOT1> . . . </RELATION>
   Note that a relation with no slots is what was referred to as a named entity.

The essence of the rules described here is to extract from the text corpus the instances of the defined relations. Relations are therefore referred to extensively throughout this description. The declaration syntax:
relation PPC(NAME, POSITION, EMPLOYER, STARTDATE);
defines a new relation “PPC”, with 4 slots.

### Macros

Macros are single instructions that expand automatically into a set of instructions which perform a task. The last part of this initial part of the rulebook may contain macros which look and perform exactly like C/C++ macros. Two examples of prevalent macros are given:

#define DefEntity(Concept, Entity, MaxLength) \
relation Entity; \
entity Entity = Entity < MaxLength; \
concept Concept -> Entity; \
Concept :- <> Entity; \
Phrase :- <−0.01,0,0> Concept Phrase

The function of this macro can be explained using an example, namely:
DefEntity(Person, PERSON, 10)
which performs the following:
1. It creates a target or relation named “PERSON”. Recall that in effect relations are the labels that CARE uses to tag the output.
2. It creates an entity non-terminal which is also called PERSON, which is defined as a sequence of between one and ten tokens labeled by the NER label “PERSON”.
3. It creates a concept—rule-based non-terminal—“Person”, which generates and is bound to the target PERSON, and which has one rule, just calling the entity non-terminal PERSON.
4. It adds a new rule for Phrase, which allows the concept Person to appear anywhere within Phrase.

The second example of a macro is:
#define permute(x,y,z) (x y z) (x z y) \ (y z x) (y x z) (z x y) (z y x)

This macro is used to generate the set of all permutations of any given three symbols. It can be applied for example to create a wordclass as follows:
wordclass wcMyPetFish=permute(my, pet, fish);

This word class would now include all the permutations of the three words:
my pet fish, my fish pet, pet my fish, fish my pet, fish pet my, pet fish my.

### Extraction of Simple Relations

This section how to write a relatively short, yet fully functional rulebook for the extraction of a specific simple relation. A relation is considered simple if it appears as one consecutive sequence in a sentence and can be relatively easily extracted. When a rulebook extracts a relation or an entity this means it aims to direct CARE how to recognize and tag all instances of this relation or entity in a given text corpus.

### Recall and Precision

The entity to be extracted is an address. In other words, the rulebook described here attempts to extract all instances of addresses from a given free language unstructured text. Since the rulebook deals with composite entities, which do not necessarily share a well-defined format, it is inevitable that some targets will be missed and conversely some false instances declared.

The extent to which all true instances are successfully extracted is called recall, and the measure of the accuracy of a declaration that an extraction is indeed a designated target is called precision.

Recall and precision are defined as follows:

Recall=TP/All

Prec=TP/(TP+FP)

where TP is True Positive, meaning correctly declared instances, FN is False Negative meaning missed instances, and FP is False Positive meaning incorrectly declared instances. It is ideally desired that recall and precision reach 100%, but as explained above this is generally impossible to attain unless the rulebook is dealing with a concept whose form can be precisely defined, such as one provided by a regular expression. Instead, there exists a delicate balance between recall and precision and the goal is a subtle threshold in which both values are optimized. Usually, precision is considered more important than recall, and thus very high precision rates are aspired to. Recall above 95% is usually considered to be very good.

### The Address Rulebook (1)

The rulebook begins with

NER “NERCRF” @(WordAll);
entity None = None < 1;
concept start Sentence;
concept state Phrase;
Sentence :- Phrase;
Phrase :- <−0.01,−0.01,0.01> None Phrase;
Phrase :- ;
#define DefEntity(Concept, Entity, MaxLength)\
relation Entity;\
entity Entity = Entity < MaxLength;\
concept Concept -> Entity;\
Concept :- <> Entity;\
Phrase :- <−0.01,−0.01,0.01> Concept Phrase
DefEntity(Person, PERSON, 10); /*note this is a NER defined label*/
DefEntity(Org, ORGANIZATION, 10); /*note this is a NER defined label*/
Relation ADDRESS /*defines a relation (=target) with the following slots (or
subfields)*/
(RECIPIENTNAME,ORG,STREETNAME,STREETTYPE,STREETNUM,CITY,
ZIP,ZIPEXTENDED,STATE,COUNTRY,POBOXNUM,SECONDUNIT,
SECONDUNITNUM, EMAIL);
/*Declare a non-terminal symbol associated with the relation ADDRESS*/
concept Address ->ADDRESS ; /*note: Address will be tagged in output:
<ADDRESS>*/
wordclass wcFirstName = %include(Wordclasses\wcFirstNames.txt);
/*The following form of macros was not previously discussed, see explanation at end of
code*/
#define SingleCapToken @Feature a“SingleCapital” @WordAll
#define CapitalToken @Feature a“Capital” @WordAll
#define AllCapitalToken @Feature a“AllCaps” @WordAll
@Feature
wordclass wcDomainWord = a“SingleCapital” a“SingleLower” a“Capital” a“AllCaps”
a“Lower”
a“MixedCase” a“NumberOne” a“NumberTwo” a“NumberOther”;
wordclass wcNum = a“NumberOne” a“NumberTwo” a“NumberOther”;
@WordAll

What remains to be explained of this is the syntax:

@Feature 1
.
.
.
@Feature2

This syntax already appears in the rulebook, at least partially, in the first line:
@(WordAll);

This is taken to be an instruction specifying the default token feature. The last few lines of code switch back and forth between the token feature WordAll and the token feature Feature. Token features are functions of tokens with string values. They are defined by regular expressions in the NER definitions file, in NERCRF_nerdefes.crf. The value of “WordAll” for a token is the token converted to lowercase. The value of “Feature” for a token is one string from the set { “Capital”, “AllCaps”, “Punctuation”, . . . }, which is chosen according to whether the token matches the regular expressions “[A-Z][a-z]+”, “[A-Z]+”, “[̂a-zA-Z0-9]”, . . . , respectively. The set of possible values and the regular expressions are all defined in the NERCRF_nerdefes.crf.

The default token feature is used in CARE in the following way: whenever a terminal symbol appears in a rule
Concept :- . . . “something” . . . ;
   the actual value which gets compared to “something” is the value of the default token feature for the current token. Thus, whenever Feature is the default token feature, the rule element “Capital” matches any capitalized token, whereas if WordAll is the default token feature, “Capital” matches only the word “capital”, but with arbitrary capitalization.

### Syntax of Rules

Rules all have the following general form:
ConceptName :- RuleBody;
   where RuleBody is one or more RuleSequences, separated by the OR-character “|”. Each RuleSequence comprises an optional Weight, followed by a sequence of zero or more RuleElements, each of which can be one of the following: a terminal symbol—“ . . . ”, a concept name, an entity non-terminal, an optional—[RuleBody], a group—(RuleBody), or a repeat—{RuleBody}. Also, any RuleElement may include a slot assignment: RuleElemen→SlotName

The Weight is denoted by angular quotes: <weight>.

A template example is given by the following:
Concept:-
<w1>[<w2> symbol_{—}1]<w3> symbol_{—}1] (<w4> symbol_{—}4|symbol_{—}5) LABEL1 {symbol5};
   where:
Concept is some non-terminal symbol which need not be previously defined;
<wn> is a numeric value indicating a weight added for the respective part of the rule;
   | is a simple, not necessarily exclusive, or;
[ . . . ] indicates an optional element to be matched in the text;
( . . . ) delineates a group of elements;
{ . . . } indicates that the elements within may be repeated 0 or more times in the text for a match; and
   indicates a target or slot of a target tagging the output.

Note that [<w> A|B] is not equivalent to [<w>A|<w> B]

To further clarify the above explanation, an example of a real rule is presented below:
Streetword :-
([<1> wcDirection] Capitalized {[“-”] Capitalized}|wcNum [“-”] “th”) STREETNAME;

Here the non-terminal symbol Streetword, is provided by the following:
1. A prefix of an optional direction such as North or S.E. is assigned a weight of 1 if it is present in the input.
2. One of the following two must come next:
   a. A mandatory capitalized token followed by any number of capitalized tokens, optionally separated by a hyphen with no weight specified so that the default weight 0 holds (e.g. “Martin Luther-King”). Note: A capitalized letter is a non-terminal symbol defined by its own rule, which must appear before this rule. It is not a rulebook keyword.
   b. A number followed by an optional hyphen and the mandatory string “th” (e.g. 7th, 8-th).
3. This entire sequence is assigned to the slot STREETNAME, which would lead to tagging with label <_STREETNAME> . . . <LSTREETNAME>.

These aforementioned rules are the main syntactic rules. The following section describes the guidelines for designating weights to the various rules and their constituents.

### Guidelines for Weighting the Rules

Some heuristics for assigning weights to the rules are now presented in order to provide insight into what the rulebook is trying to achieve.
1. Generally, the continuous range of possible weights can be divided into several broad classes:
By Sign—into positive and negative weights; and
By Magnitude—into small (about 0.1), medium (about 1) and large (about 10).
In general, the exact value is not significant provided that it is in the correct class. Often the magnitude is not significant either, and only the sign is important.
2. Add a large positive weight to rules that are highly indicative of a relation, meaning that they either have a large amount of context clues or that the context clues are decisive. For example:
Phrase :- <10> “domain” “name” “:” DomainName Phrase;
means that if the string “domain name:” appears in the input text, it is almost certain that it is followed by a DomainName.
   Another example is:
Domain :- DomainX [<10> “.” “com”];
which means that if “.com” appears within a “Domain”, it almost certainly the end of the domain, although sometimes “Domains” end in other tokens such as “.org”.
3. Add a medium positive weight to signify indicative clues which are not definite, to determine the correctness of the rule itself. An example is:
PhoneNum :- [<1> “+” wcPhoneNum]
[<1> “(“wcPhoneNum”)”|“.”]
wcPhoneNum [[<1> “-”] wcPhoneNum [[<1> “-”]wcPhoneNum]];

A phone number has the general form of +X(XXX)XX-XX-XX. The appearance of any one small clue does not guarantee that the result is definitely a phone number, but if all the small clues appear, namely a plus sign, brackets and minus signs, there is a cumulatively high chance that this indeed is a phone number.
4. Add a small positive weight to a “generic” rule, which needs to be greedy. The next two rules serve as examples:
DomainWord :- <0.1> wcDomainWord [[“-” |“_”] DomainWord|wcNum];
DomainX :- DomainWord [“.” DomainX];

The idea here is that the non-terminal symbol “DomainX” should consume as many tokens as possible, as long as other higher-weight constraints do not match. Such higher-weight constraints may come from NER when a high-probability entity occurs or from another CARE rule.
5. Add a small negative weight to a “generic” rule, which should be non-greedy.
6. Add a medium negative weight to a weak “generic” rule, in other words a rule which should only match if other external very strong contextual clues are present elsewhere, before or after, in the parse tree.

Sometimes it may be necessary to raise or lower particular weights in order to resolve conflicts between competing rules. Also, after a rulebook is trained using a training data corpus, the accuracy of the parsing should increase significantly.

### The Address Rulebook (2)

A complete basic rulebook is now presented with annotations. /* . . . */ and // . . . denote comments, enclosed and until end of line, respectively.

```
//continuation of rulebook
DomainWord :- <0.1> wcDomainWord [(″-″ \ ″_″) DomainWord \ wcNum];
Domain :- DomainWord [″.″ Domain];//recursive rule allowing an unlimited number of
″.″ extensions.
/*The following is an example of a very clear clue appearing inside a rule (″email″).
Generally such rules are very effective in terms of precision, however, they compromise
the generality of the rulebook, as such clues are obviously corpus-specific, and may
reduce recall if used incorrectly. Note the high score assigned to the optional
component ″email″ which obviously specifies an email address with a high
probability*/
eMailAddress :- <0.1> [<10>(″e″ ″-″ ″mail″ \ ″email″) [″:″]] DomainWord [″.″
DomainWord] ″@″
Domain;
/*Various useful wordclasses. Note that corresponding files should be placed in a
directory
″wordclasses″ under the executing directory*/
wordclass wcStreetAbbt = %include(Wordclasses\wcStreetSuffixAbbrv.txt);
wordclass wcStates = %include(Wordclasses\wcStates.txt);
wordclass wcStatesAbbr = %include(Wordclasses\wcStatesAbbr.txt);
wordclass wcCities = %include(Wordclasses\wcCities.txt);
wordclass wcCountries = %include(Wordclasses\wcCountries.txt);
wordclass wcSecondaryUnitsNoNum =
basement bsmt front frnt lobby lbby lower lowr
office ofc penthouse ph upper uppr rear rear side side;
wordclass wcSecondaryUnits =
apartment apt building bldg department dept floor fl hanger
hngr key key lot lot pier pier room rm slip slip
space spc stop stop suite ste trailer trlr unit unit ;
wordclass wcOrgTypes =
(air force) police college (media center) university airport academy office cabinet
government
administration commission institute board agency radio department (executive board)
committee court parliament union partnership ministry army republic team party
council management association bank center church club congress foundation fund
group magazine (medical center) network organization partnership school team union
brigades;
/*AllCapitalToken and CapitalToken are defined by macros in the preamble*/
Capitalized :- (AllCapitalToken \ CapitalToken);
wordclass wcDirection = north n (n ″.″) east e (e ″.″)
south s (s ″.″) west w (w ″.″)
northeast ne (n ″.″ e ″.″) (n ″.″ e)
southeast se (s ″.″ s ″.″) (s ″.″ s)
northwest nw (n ″.″ w ″.″) (n ″.″ w)
southwest sw (s ″.″ w ″.″) (s ″.″ w);
/*Here a number of auxiliary non-terminals are used to help define a more complex
non-terminal ″Recipient″. This is a standard technique to employ. Note the small
positive weights assigned to each potential non-terminal*/
RecO :- <0.1> ORGANIZATION ORG;
RecP :- <0.1> PERSON->RECIPIENTNAME {<0.1> (″,″\″and″) PERSON
  RECIPIENTNAME };
/*recall {...} denotes an arbitrary (possibly 0) number of repetitions*/
RecE :- <0.1> eMailAddress EMAIL;
Recipient :- RecO [[″,″] RecP] [[″,″] RecE] //or
| RecO [″,″] RecE [″,″] RecP //or
| RecP [[″,″] RecO] [[″,″] RecE] //or
| RecP [″,″] RecE [″,″] RecO //or
| RecE [[″,″] RecP] [[″,″] RecO] //or
| RecE [″,″] RecO [″,″] RecP; //or
//note the very high score assigned to this rule because of the almost certain clue “po”
(optional ″box″)
POBox :- <10> (″p″ [″.″] ″o″ [″.″] \ ″po″) [″box″] wcNum POBOXNUM;
Streetword :- [<1> wcDirection] (<1> Capitalized { [″-″] Capitalized } \ wcNum [″-″]
″th″);
StreetAddr :- /*either form works: Jaffa st. 37 or 37 Jaffa st.
<10> Streetword STREETNAME wcStreetAbbt->STREETTYPE [″.″] wcNum
  STREETNUM //or:
| <10> wcNum->STREETNUM [″-″] Streetword->STREETNAME wcStreetAbbt-
>STREETTYPE [″.″];
Secondary Unit :-
<10> wcSecondaryUnits->SECONDUNIT wcNum SECONDUNITNUM //or
| <10> wcSecondaryUnitsNoNum SECONDUNIT [<1> wcNum-
>SECONDUNITNUM];
/*note that city is either from wordclass list (with very high weight = 10) or with a
general capitalized word (with negative score = −1)*/
City :- <10> ([wcDirection] wcCities)->CITY
| <−1> (Capitalized [ <−1> [″-″ \ ″.″] Capitalized ])->CITY;
State :- <10> (wcStates \ wcStatesAbbr)->STATE;
ZipCode :- wcNum->ZIP [<1> ″-″ wcNum->ZIPEXTENDED];
Country :- <10> wcCountries->COUNTRY;
/*Finally we can define the complete concept we aim to extract*/
Address :- [Recipient [″.″\″,″]]
(POBox \ StreetAddr) [″.″\″,″]
[SecondaryUnit [″.″\″,″]]
[([Capitalized][Capitalized] wcOrgTypes)]//allow additional name of company
[City [″.″\″,″]]
[State [″.″\″,″]]
[ZipCode [″.″\″,″]]
[Country] [″.″];
/*This line is crucial for the rulebook. */
Phrase :- Address Phrase;
/*The reason the above rule is crucial is because without it, the concept Address would
never be matched, as it would not have been “connected” to the initial symbol
“Sentence” (which in turn is expanded to “Phrase”)*/
```

### Technical Information for Running CARE

In order to run CARE, a directory containing the following files needs to be created:
1. corpus.txt—the corpus to be parsed.
2. Rulebook.rec—the rulebook.
3. NERCRF_nerdefs.crf—the NER definitions file.
4. NERCRF_nermodel.crf—the NER trained model file.
5. NERCCRF_nerprep.crf—NER preprocessed information.
6. CRFStuff.dll—dlls needed to run the CARE executable.
7. RE_CRF.exe—the CARE engine executable.
8. Wordclasses—a directory containing all word class files to be included by the rulebook.

In order to run CARE on a given rulebook the following line is typed at the command prompt:
RE_CRF.exe—process RuleBook.rec <Corpus.txt > results

This compiles the rulebook RuleBook.rec, runs it over Corpus.txt and places the tagged corpus in a new file “results”.

Note that a corpus must be in the following format:

<DOCUMENT>
<S> A sentence starts with an “S” tag, and can span many physical
sentences, but should not contain XML tags. </S>
<S>Any amount of sentences is allowed within every document type </S>
<S> A document starts and begins with a DOCUMENT tag </S>
</DOCUMENT>
<DOCUMENT>
<S>Any amount of documents is allowed within a corpus. </S>
<S>For example...</S>
</DOCUMENT>
<DOCUMENT>
<S>This corpus as is will be compiled by any legal rulebook</S>
<S>However this corpus will not be tagged for any addresses </S>
</DOCUMENT>

### Extraction of Complex Relations

A complex relation refers to a relation with multiple slots, which may be broken up into segments across a sentence. As implied by the structure of the legal corpus provided hereinabove, the basic units that CARE knows how to deal with are sentences as delineated by the tag <S> . . . </S>. Extracting any relation that spans several sentences must be done in post-processing and is therefore beyond the scope of this description.

Obviously, there is no one way of writing a rulebook, in particular for extracting a complex relation. However, there are some very useful tricks and tips which are presented below.

### Creating Verb Tables

The following is an example of how macros can be harnessed to create very general and comprehensive wordclasses using a few simple instructions: For example, a rulebook needs to be written in order to identify a complex relation between a Person, the Company the Person works for and the Person's Position at that company (PPC),In order to extract such a relation the basic constituents, namely people, companies and positions must be identifiable as well as the relationship binding them together. A few examples are provided in the following sentences, wherein relation constituents are marked in bold:
Dr. John Doe was recently appointed CEO of Coca-Cola Inc.
The fact that Mr. Bigelow will now be promoted to position of COO at BMW was received in the media with mixed feelings.
Major Grurlovski, formerly a retired fisherman, had been later elected to serve as president of Insomniacs Algorithms LTD.

Aside from the three constituents, these sentences all seem to contain a verb indicating that the person was appointed to the job. The question is how such verbs can be identified inside sentences since they seem to be in so many different tenses, conjunctions and positions. To answer this question, first a macro is defined that generates a set in which an element x is moved across a sequence w1, . . . , wn, while keeping the sequence's order fixed:
#define Around1(w, x) (x w) (w x)
#define Around2(w1, w2, x) (x w1 w2) (w1 x w2) (w1 w2 x)
#define Around3(w1, w2, w3, x) (x w1 w2 w3) (w1 x w2 w3) (w1 w2 x w3) (w1 w2 w3 x)

Then, an auxiliary macro is defined which will help create the active forms of a given verb.

#define VerbFormsActive_X(root, v, s, ing, ed, en, x) \/* the “\”allows
breaking a line before “;” */
Around1(root##v, x) Around1(root##s, x) \/* ## denotes tokens which
must appear with no spaces between them*/
Around1(root##ed, x) \
Around1(root##ing, x) Around2(is, root##ing, x) Around2(are,
root##ing, x) \
Around2(was, root##ing, x) Around2(were, root##ing, x) \
Around2(has, root##en, x) Around2(have, root##en, x) Around2(had,
root##en, x) \
Around3(has, been, root##ing, x) Around3(have, been, root##ing, x)
Around3(had, been, root##ing, x) \
Around2(will, root##v, x) Around2(shall, root##v, x);

To show how this macro works, it can be fed with the following input set:
(nam, e, es, ing, ed, ed,)

The last parameter is empty, which is a legal syntax for omitting a parameter. Additionally, the last two parameters are identical, since the perfect tense of the verb “to name” is “has named” and not “has namen”. The result of feeding the above set to the macro is:
name, names, named, naming, is naming, are naming, was naming, were naming, has named, have named, had named, has been naming, have been naming, had been naming, will name, shall name

Had the input set included the last parameter, such as:
(nam, e, es, ing, ed, ed, recently)
a much larger output would have been produced, namely
recently name, name recently, names recently, names recently, recently named, named recently, recently naming, naming recently , recently is naming, is recently naming, is naming recently, recently are naming, are recently naming, are naming recently, recently was naming, was recently naming, was naming recently, recently were naming, were recently naming, were naming recently, recently has named, has recently named, has named recently, recently have named, have recently named, have named recently, recently had named, had recently named, had named recently, recently has been naming, has recently been naming, has been recently naming, has been naming recently, recently have been naming, have recently been naming, have been recently naming, have been naming recently, recently had been naming, had recently been naming, had been recently naming, had been naming recently, recently will name, will recently name, will name recently, recently shall name, shall recently name, shall name recently

This example shows how powerful the macro is. Now this auxiliary macro is used as input to a more general macro to generate a full word class of active verb forms:

#define VerbFormsActive(root, v, s, ing, ed, en) \
VerbFormsActive_X(root, v, s, ing, ed, en, ) \
VerbFormsActive_X(root, v, s, ing, ed, en, currently) \
VerbFormsActive_X(root, v, s, ing, ed, en, formerly) \
VerbFormsActive_X(root, v, s, ing, ed, en, previously) \
VerbFormsActive_X(root, v, s, ing, ed, en, recently) \
VerbFormsActive_X(root, v, s, ing, ed, en, most recently) \
VerbFormsActive_X(root, v, s, ing, ed, en, presently) \
VerbFormsActive_X(root, v, s, ing, ed, en, lately) \
VerbFormsActive_X(root, v, s, ing, ed, en, also) \
VerbFormsActive_X(root, v, s, ing, ed, en, now) \
VerbFormsActive_X(root, v, s, ing, ed, en, later);

In order to generate almost any active verb with the stem verb “promote” it is sufficient to write:
VerbFormsActive(promot, e, es, ing, ed, ed)
The wordclass of verbs that will be generated is:
wordclass wcAppoint=VerbFormsActive(appoint, s, ing, ed, ed)
VerbFormsActive(reappoint, s, ing, ed, ed)
VerbFormsActive(re “-” appoint, s, ing, ed, ed)
VerbFormsActive(nam, e, es, ing, ed, ed)
VerbFormsActive(elect, s, ing, ed, ed)
VerbFormsActive(reelect, s, ing, ed, ed)
VerbFormsActive(re “-” elect, s, ing, ed, ed)
VerbFormsActive(engag, e, es, ing, ed, ed)
VerbFormsActive(select, s, ing, ed, ed)
VerbFormsActive(, choose, chooses, choosing, chose, chosen)
VerbFormsActive(promot, e, es, ing, ed, ed)
VerbFormsActive(employ, s, ing, ed, ed);

For irregular verbs, such as “choose” above, all the conjugations are explicitly specified, manually omitting the stem or root. Similar macros can be specified for passive forms of verbs:

#define VerbFormsPassive_X(verb_en, x) \
Around3(has, been, verb_en, x) \
Around3(have, been, verb_en, x) \
Around3(had, been, verb_en, x) \
Around2(is, verb_en, x) Around2(are, verb_en, x) \
Around2(was, verb_en, x) Around2(were, verb_en, x) \
Around3(will, be, verb_en, x) \
Around3(shall, be, verb_en, x)

which is used as an auxiliary macro for the following macro:

#define VerbFormsPassive(verb_en) \
VerbFormsPassive_X(verb_en,) \
VerbFormsPassive_X(verb_en, currently) \
VerbFormsPassive_X(verb_en, formerly) \
VerbFormsPassive_X(verb_en, previously) \
VerbFormsPassive_X(verb_en, recently) \
VerbFormsPassive_X(verb_en, most recently) \
VerbFormsPassive_X(verb_en, presently) \
VerbFormsPassive_X(verb_en, lately) \
VerbFormsPassive_X(verb_en, also) \
VerbFormsPassive_X(verb_en, now) \
VerbFormsPassive_X(verb_en, later)

A symmetric analysis of these macros is omitted here, however their use is be clear from the above description.

Determining the Relative Position in which a Relation Can Appear

There are several standard ways in which a calling rule for a relation, pointed to by a concept, can be added into the rulebook. Three of the most prevalent ways to do so are presented here.
1. Phrase :- RelationConcept Phrase;

“Phrase” is meant to match an arbitrary sequence of entities, relations, and “None”s, as specified by the standard preamble rule:
Phrase :- <−0.01,−0.01,0.01> None Phrase;

Phrase can be visualized as a state in a FSA with multiple transitions to itself, labeled by every possible entity and relation, and one ending transition, defined by:
Phrase :- ;
This calling rule allows RelationConcept to appear anywhere within any sentence.
2. Sentence :- RelationConcept;
“Sentence” is the top non-terminal for the whole parse. Therefore, the rule above says that RelationConcept has to extend over the entire sentence. It should be noted that “Phrase” is normally connected to “Sentence” by the rule Sentence :- Phrase;
3. Sentence :- RelationConcept Phrase;
This rule says that the RelationConcept may appear only at the beginning of a sentence, but can be then followed by anything.

### Rules for a Complex Relation

The rules for a complex relation are presented here. The following code is an excerpt from a rulebook for PPC extraction:

//---------------- General wordclasses definitions ----------------
wordclass wcTimeAdverb = currently formerly previously recently (most recently)
presently lately also now later;
wordclass wcTimeAdj = current former previous recent (most recent) latest early
present later last first next late;
wordclass wcDet = the a an;
wordclass wcForAtInOf = for at in of;
wordclass wcInAtOfForWith = in at of for with within;
wordclass wcInAtOfForWithByOn = in at of for with within by on;
//---------------- PPC rules ----------------
//---------------PPC specific wordclasses definitions-----------------
//for brevity reasons, long wordclasses are abbreviated and are presented only in part
wordclass wcIsWas = VerbFormsPassive( );
wordclass wcServe = VerbFormsActive(serv, e, es, ing, ed, ed);
wordclass wcAppoint = VerbFormsActive(appoint, , s, ing, ed, ed)
VerbFormsActive(nam, e, es, ing, ed, ed)
VerbFormsActive(elect, , s, ing, ed, ed)
VerbFormsActive(, choose, chooses, choosing, chose, chosen)
VerbFormsActive(promot, e, es, ing, ed, ed)
VerbFormsActive(employ, , s, ing, ed, ed);//etc...
wordclass wcWasAppointed = VerbFormsPassive(appointed)//etc...
//etc........ some wordclasses omitted
wordclass wcSucceed = VerbFormsActive(succeed, , s, ing, ed, ed);
wordclass wcBecome = VerbFormsActive(, become, becomes, becoming, became,
become);
wordclass wcRetired = VerbFormsActive(retir, e, es, ing, ed, ed);
wordclass wcWasFired = VerbFormsPassive(fired);
wordclass wcHold = VerbFormsActive(, hold, holds, holding, held, held)
VerbFormsActive(assum, e, es, ing, ed, ed);
wordclass wcJoin = VerbFormsActive(join, , s, ing, ed, ed)
VerbFormsActive(, come to, comes to, coming to, came to, come to);
wordclass wcWasEmployed = VerbFormsPassive(employed);
wordclass wcLead = VerbFormsActive(, lead, leads, leading, lead, lead);
wordclass wcInclude = VerbFormsActive(includ, e, es, ing, ed, ed);
wordclass wcAsToFromPosition = as (as “:”)
(in the position of) (from the position of) (from the newly created position of)
(to the position of) (for the position of) (for the positions of); //etc...
wordclass wcPosition = position positions (several positions)
(senior level position) (senior level positions); //etc...
wordclass wcAsOfIncluding = as of including (including “:”);
wordclass wcJob = job assignment jobs assignments;
//------------midlevel rules-------------
// Note, not all symbols are defined in this code excerpt, some are provided in earlier
parts and are omitted
//here, for brevity
//Most importantly the auxiliary concepts: OrgX, PersonX and PositionX were earlier
defined.
//They should be understood as auxiliary symbols representing Organizations Persons
and
//Positions, respectively.
//for example here is part of the definition of PersonX:
Person :- <3> PERSON “,” wcRomanNum; //Note: PERSON is the NER entity!
PersonX :- Person->NAME [“,” (“phd” | “ph” [“.”] “d” [“.”] | “md”)];
PersonX :- (“he” | “she” | <−2> “and”)->NAME;
//other symbols not fully defined within the code excerpt should be understood by their
suggestive
//name:
PriorToJoiningOrg :- <0.01> (((“prior” “to” | “before” | “since” | “until”) [“joining”] |
“having”
“joined”) OrgX [InDate] [<1> wcAsToFromPosition PositionX] [“,”]);
PriorToInDate :- PriorToJoiningOrg;
PriorToInDate :- <0.01> InDate [“,”];
PosOrg :- <1> [wcAsToFromPosition|“of”] PositionX [[“,”] [ <3> wcInAtOfForWith]
OrgX] [InDate];
PosOrg :- (OrgX | OrgXPossessive) PositionX;
PosOrgList :- PosOrg [(“;” | “,” | “and”) PosOrgList];
OrgPos :- [wcInAtOfForWith] OrgX [[“,”] [wcAsToFromPosition] PositionX]
[InDate];
OrgPosList :- OrgPos [(“;” | “,” | “and”) OrgPosList];
//------------Actual PPC rules-----------------
//All of the previous code was provided in order to define the following recognizing
rules:
//The following rule matches instances such as:
// prior to joining BMW in 1989 as CEO, Arthur Dent served as Ferrari's CFO since
April 1985.
PPC :- [PriorToInDate] PersonX [InDate]
(wcServe [NumYears] wcAsToFromPosition |
wcRetired wcAsToFromPosition |
wcIsWas |
wcWasAppointed [wcAsToFromPosition] |
wcHold [wcDet] wcPosition wcAsOfIncluding |
wcBecome)
(PosOrgList | OrgXPossessive PositionX) [InDate];
/*Here the tagging should look as follows:
<PERSONPOSITIONCOMPANY>
Prior to joining <_EMPLOYER>BMW</_EMPLOYER> in 1989 as
<_POSITION>CEO</_POSITION>, <_NAME>Arthur Dent</_NAME> served as
<_EMPLOYER>Ferrari </_EMPLOYER>'s
<_POSITION>CFO<_POSITION> since April 1985.
</PERSONPOSITIONCOMPANY>
*/
//There exist many other rules that extract PPC relations, a few of these are shown in the
next few lines:
PPC :- OrgX “,” “where” PersonX wcHold [wcDet] wcPosition “of” PositionX;
//one more sample sentence:
// BMW, where Arthur Finkelstein, held the position of President
PPC :- [PriorToInDate] PersonX wcRetired [InDate] “from” OrgX [InDate]
[wcAsToFromPosition PositionX];
PPC :- PriorToJoiningOrg PersonX;
PPC :- wcAsToFromPosition PositionX wcInAtOfForWith OrgX “,” PersonX;
PPC :- wcAsToFromPosition PositionX “,” PersonX “will” [“ensure” “that” OrgX];
PPC :- PersonX “began” (“his”|“her”) (“career”|“employment”) [InDate]
(wcAsToFromPosition PositionX [InDate] [wcInAtOfForWithByOn OrgX] |
wcInAtOfForWithByOn OrgX [InDate] [wcAsToFromPosition PositionX]) [InDate];
PPC :- PersonX wcLead OrgX;
PPC :- “positions” “held” “by” PersonX [“,”] (wcInclude | “including”) [“those” “of”]
PosOrgList;
PPC :- PersonXPossessive [“professional”] “experience” wcInclude “positions”
[“such”] “as” PosOrgList;

It is instructive to show how to ensure that PPC instances are indeed tagged in the output:

//let the concept point to the target relation
concept PERSONPOSITIONCOMPANY ->
PERSONPOSITIONCOMPANY;
//expand PERSONPOSITIONCOMPANY as PPC
PERSONPOSITIONCOMPANY :- PPC;
//finally allow PPC to appear anywhere in a sentence
Phrase :- PERSONPOSITIONCOMPANY Phrase;

### General Guidelines for Improving the Rulebook: Aggregation, Conciseness, Repeated Iterations and Training

Writing a rulebook is a creative process in which not all instances to be extracted can be predicted in advance. A rulebook often starts out as a simple collection of elementary rules that undergo modifications and extensions, unfortunately sometimes up to a point of congestion. Before such a state is reached, it is important to restructure the rules, so that medium level common phrases are aggregated into auxiliary midlevel rules, as depicted in aforementioned example (OrgX, PersonX).

In order to build comprehensible and effective rulebooks, it is important to invest some time in articulating the rules elegantly, so that the result is concise, readable, modular and extensible. There will always be new instances not “caught” by the rulebook. Repeated iterations over the tagged results will be needed to ensure that the correct instances are extracted, but even then it is unlikely to cover all possible cases, unless the relation is extremely simple or given completely by deterministic clues. However, if an effort is made to organize the rules in a readable manner, it will make the work of extending the rulebook effectively much easier. Another aspect, in which creativity is evinced, is in the weights assigned to the rules. A delicate balance sometimes needs to be reached between competing rules. Producing a precise and extensive training corpus for the rules will also affect the accuracy of the rulebook.

### Additional Syntax

This section contains additional CARE syntax and tips for reducing the compilation time of rulebooks.

### Explicit Regular Expressions

At a later stage of CARE development, an explicit syntax for manipulating regular expressions was added as an integral part of the CARE syntax. The syntax employed is that of Perl's Regular Expressions. Full documentation is available on the Internet and is beyond the scope of this description. However, several examples and explanations of usage are presented below:
Num3Digits :- /̂\s*\d{3}\s*$/ None;

### Explanation:

a. Num3Digits is a concept defined by the regular expression /̂\s*\d{3}\s*$/
b. As in Perl the / . . . / is a zero-length non-consuming forward check.
c. In order to be consumed, place a None token after the regular expression—this signals to the tokenizer to actually catch the regular expression and not only match it. Note that omitting the None token after the regular expression, will result in the concept not catching anything.
d. Regular expressions usually begin with ̂\s* and end with \s*$ to account for trailing spaces, omitting them will allow for zero-space tests.
e. The above regular expression catches any number with exactly three digits.
f. Finally, it is important to note that / . . . / checks exactly one token, together with its heading and trailing spaces. The definition of a token resides in the NER definitions file. If a definition of a token changes for some reason, the regular expressions may need to be changed.

The following are several additional examples:
Num2Digits :- /̂\s*\d{2}\s*$/ None;
   As above this concept will match any number with exactly two digits.
NumDigits1_{—}3 :- /̂\s*\d{1,3}\s*$/ None;
   As above this concept will match any number with at least one and no more than three digits.
MixedCase:- /̂\s*[a-z]+[A-Z]+[a-zA-Z]*\s*$/ None;
   This concept will catch any word starting in lowercase and containing at least one upper case letter.
Begins UpperCase:- /̂\s*[A-Z]+[a-zA-Z]*\s*$/ None;
   This concept will catch any word starting in uppercase and then containing letters of any case

Note that these concepts, once defined, can be used as any other concept would be used, for example:
CrazyText :- <1> MixedCase|BeginsUpperCase;
   This concept matches any token matching either MixedCase or BeginsUpperCase.
   Reducing Compilation Time with Skipnorm

Long rulebooks may take a significant time to compile, up to 3-6 minutes. This becomes a major impediment for development when a rulebook needs to be regularly updated to handle new examples.

A solution for reducing compilation time does exist. In fact, the long compilation time is almost entirely due to normalization of wordclasses. In order to skip normalization of wordclasses simply use the following syntax:
wordclass skipnorm wcWordClassName=one two three . . . ;
   “skipnorm”, should be used with caution, only when normalization is not required. More specifically in order to add skipnorm to a wordclass declaration, the following conditions must be fulfilled:
a. All of the sequences in the wordclass must be correctly tokenized with spaces between tokens and multi-token sequences delimited by parentheses.
b. All of sequences in the word class must be normalized (i.e. in lowercase for the standard token feature).
   Finally, it is noted, that skipnorm will only have a noticeable effect for large wordclasses, namely those loaded from large external files and/or wordclasses automatically generated using macros (as are the verb tables).

### Experiments

Experiments are described here for three main purposes. Firstly, the experiments demonstrate the present invention's ability to cope with complex structures and to successfully extract relations with very high accuracy (95% and higher) in terms of both precision and recall. The present invention achieves this accuracy using a standard training corpus for training a named entity recognition model and a limited number of manually-written relation extraction rules. Secondly, the experiments demonstrate the importance of various parts of the present invention's architecture. This is shown by a series of “handicap” experiments, in which one of the key components of the system is disabled. Thirdly, the experiments show that although training the weights of the CARE grammar automatically is possible, it produces worse results than setting the weights manually and in an intuitive way.

No precise numerical comparisons to other relation extraction systems are attempted, due to the difficulty of establishing a standard benchmark test. Instead, comparisons are made at qualitative levels.

### The Achievable Accuracy Experiment

In this experiment a complete PPC (“Person-Position-Company”) rulebook is used, working with a CRF-based NER model trained on the CoNLL-2003 shared task data. The experimental corpus is a large set of short biography pages from the BusinessWeek website. In order to test the performance of the system a random set of ten such pages was taken containing 113 instances of the PPC relation. The rulebook was run on these pages and the results were then checked manually. The results themselves have the same basic form as that shown in FIG. 1. The statistics are shown in FIG. 3.

It is difficult to numerically define the accuracy measures for a tree-structured output. Consequently, two different sets of measures are used: one takes into account only the accuracy of slot assignments, irrespective of the structure, whereas the other counts the number of correctly extracted “final” relations produced after post-processing the CARE output. This second measure indirectly takes the structure into account. Two counts are shown, the “exact” and “partial”. For the “exact” count, an extracted instance is considered a “true positive” if all of the slots of the relation instance are found and correctly filled. For the “partial” count, the position and dates can be missed, but not incorrectly filled.

### The “Handicapped” Experiments

In these experiments, the importance of the various parts of CARE architecture is demonstrated by disabling them in turn and evaluating the results produced by the handicapped systems.

There are two such experiments. In the first experiment, the flexible interface between CARE and NER is disabled, in effect making all NER decisions immutable. In the second experiment, NER is disabled altogether by making the weights of all NER transitions equal, so that all named entity recognition decisions are made by the rules. The second experiment is thus seen to be the opposite of the first.

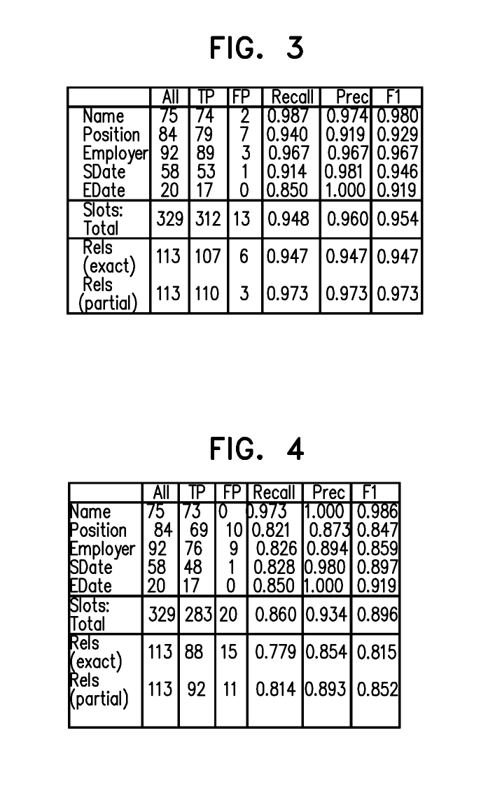

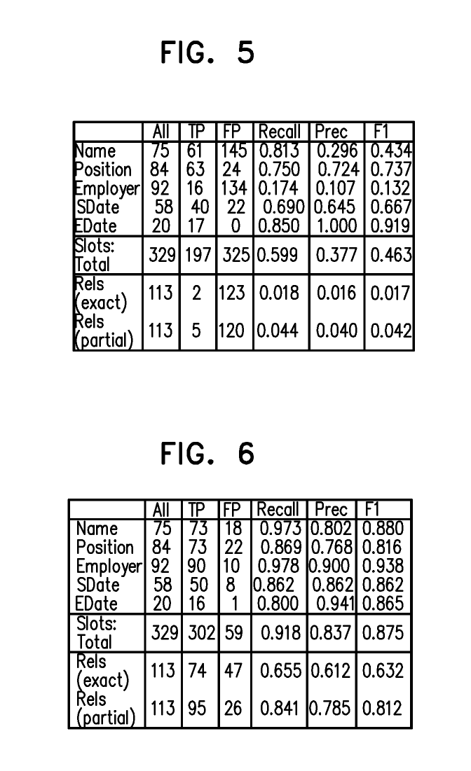

The statistics for these two experiments are shown in FIGS. 4 and 5. As is evident from the statistics shown in FIG. 5, the presence of a NER system is extremely important and relation patterns alone are insufficient. However, the statistics shown in FIG. 4 demonstrate that the NER system makes many mistakes when it operates alone. If the NER classification is immutable, the results are far worse—by 13% of F1-points in the “exact relations” measure. It is interesting to note the difference between “Total slots” and “exact relations” accuracy. For the full system, whose results are shown in FIG. 3, these measures are very close. This means that most of the errors made by the system are “whole relation” errors where a relation may be missing or totally wrong. In contrast, for the handicapped system whose results are shown FIG. 4, there are many relations with partially wrong information, produced by incorrectly extracted entities.

The Training experiment

In this experiment the results of a system in which the weights were trained instead of being set manually and in an intuitive way are shown. The amount of training data used was relatively small due to the difficulty in labeling a sufficiently large training corpus. The results in FIG. 6 clearly demonstrate that the accuracy of an automatically trained system is much lower than the accuracy of a system for which the weights are set manually. For comparison's sake, the results of a totally untrained system are all zeros.

It will be appreciated by persons skilled in the art that the present invention is not limited to what has been particularly shown and described hereinabove. Rather the scope of the present invention includes both combinations and subcombinations of various features described hereinabove as well as modifications of such features which would occur to a person of ordinary skill in the art upon reading the foregoing description and which are not in the prior art.

1. A system for extracting information from text, said system comprising:
parsing functionality operative to parse a text using a grammar, said parsing functionality including:
named entity recognition functionality operative to recognize named entities and recognition probabilities associated therewith; and
relationship extraction functionality operative to utilize said named entities and said probabilities to determine relationships between said named entities; and
storage functionality operative to store outputs of said parsing functionality in a database.

2. A system for extracting information from text, said system comprising:
parsing functionality operative to parse a text using a grammar, said grammar including a plurality of rules, at least some of said plurality of said rules having different weights assigned thereto, said parsing functionality employing said weights to select preferred results of said parsing; and
storage functionality operative to store outputs of said parsing functionality in a database.

3. A system for extracting information from text according to claim 2 and wherein said parsing functionality includes:
named entity recognition functionality operative to recognize named entities and recognition probabilities associated therewith; and
relationship extraction functionality operative to utilize said named entities and said probabilities to determine relationships between said named entities.

4. A system for extracting information from text according to claim 3 and wherein both said weights and said probabilities are employed to select preferred results of said parsing.

5. A system for extracting information from text according to claim 4 and wherein said weights are trained using a labeled corpus.

6. A system for extracting information from text according to claim 4 and wherein said weights are specified by a knowledge engineer.

7. A system for extracting information from text according to claim 2 and wherein said rules utilize results of sequence classifiers.

8. A method for extracting information from text, said method comprising:
parsing a text using a grammar, said parsing including:
recognizing named entities and recognition probabilities associated therewith; and
utilizing said named entities and said probabilities to determine relationships between said named entities; and
storing outputs of said parsing in a database.

9. A method for extracting information from text, said method comprising:
parsing a text using a grammar, said grammar including a plurality of rules, at least some of said plurality of said rules having different weights assigned thereto, said parsing employing said weights to select preferred results of said parsing; and
storing outputs of said parsing in a database.

10. A method for extracting information from text according to claim 9 and wherein said parsing includes:
recognizing named entities and recognition probabilities associated therewith; and
utilizing said named entities and said probabilities to determine relationships between said named entities.

11. A method for extracting information from text according to claim 10 and wherein both said weights and said probabilities are employed to select preferred results of said parsing.

12. A method for extracting information from text according to claim 11 and wherein said weights are trained using a labeled corpus.

13. A method for extracting information from text according to claim 11 and wherein said weights are specified by a knowledge engineer.

14. A method for extracting information from text according to claim 9 and wherein said rules utilize results of sequence classifiers.
